(19) United States
(12) Patent Application Publication
(10) Pub. No.: US 2017/0249640 A1
(43) Pub. Date: Aug. 31, 2017

(54) Commerce Card System And Method OF Using Same

(71) Applicant: 1020, Inc., San Francisco, CA (US)

(72) Inventors: Anne Bezancon, Oakland, CA (US); Daniel Parkes, San Francisco, CA (US)

(73) Assignee: 1020, Inc.

(21) Appl. No.: 15/594,850

(22) Filed: May 15, 2017

Related U.S. Application Data
(62) Division of application No. 14/290,875, filed on May 29, 2014.
(60) Provisional application No. 61/829,127, filed on May 30, 2013.

(51) Int. Cl. G06Q 20/40; G06Q 20/20; G06Q 20/32

(52) U.S. Cl. CPC G06Q 20/4016; G06Q 20/3224; G06Q 20/405; G06Q 20/20; G06Q 20/409

(57) ABSTRACT

A system and method for authorizing a transaction that includes a transaction device configured to send over a network information relating to a transaction and a commerce card and a transaction processing device configured to receive over the network the information sent by the transaction device and information sent from a mobile device associated with the commerce card. The transaction processing device is configured to authorize the transaction based on the information received from the transaction device and the information received from the mobile device. The transaction processing device can also authorize the transaction at last in part on criteria associated with the commerce card.

### RELATED APPLICATIONS

This application is a divisional of U.S. patent application Ser. No. 14/290,875, which claims the benefit of U.S. Provisional Application No. 61/829,127 filed May 30, 2013, and which are incorporated herein by reference.

### FIELD OF THE INVENTION

The present invention relates to a commerce card system and method for purchasing goods and services.

### BACKGROUND OF THE INVENTION

Currently, several types of cards have been traditionally used for purchasing goods and services. For example, credit cards are well known, whereby the user is billed after the purchase of goods/services using the credit card. Debit cards are tied to a particular bank account, whereby the cost of goods/services purchased using the debit card is automatically deducted from the bank account. Usually debit cards require the user to input a PIN (personal identification number) to complete the transaction. Merchant cards are tied to a user account established with a particular merchant, where users load the account with money, and the cost of goods/services purchased from the merchant is deducted from the user's account. Gift cards are purchased in advance, and the cost of goods/services purchased using the gift card is deducted from the balance associated with the gift card until the gift card's balance is depleted or replenished.

The problems with all the aforementioned cards include that anyone possessing the card can purchase any goods/services at any time (assuming no PIN requirement). A party that issues or gifts a card to another party has no control how the card will be used. Additionally, users with self-control spending issues may abuse the spending power the card gives them (up to the card's limit). A user that shares a card with another user has no control over the other user's purchases. Fraudulent purchases can easily occur if the card or its number identifier is lost or stolen.

There is a need for a card usable in commerce that addresses these issues.

### BRIEF SUMMARY OF THE INVENTION

The aforementioned issue are addressed by a method of authorizing a transaction that includes receiving, by a transaction processing device over a network, information relating to a transaction and a commerce card sent by a transaction device; receiving, by the transaction processing device over a network, information sent from a mobile device associated with the commerce card; and authorizing, by the transaction processing device, the transaction based on the information received from the transaction device and the information received from the mobile device.

A system for authorizing a transaction includes a transaction device configured to send over a network information relating to a transaction and a commerce card; and a transaction processing device configured to receive over the network the information sent by the transaction device and information sent from a mobile device associated with the commerce card, wherein the transaction processing device is configured to authorize the transaction based on the information received from the transaction device and the information received from the mobile device.

Other objects and features of the present invention will become apparent by a review of the specification, claims and appended figures.

### BRIEF DESCRIPTION OF THE DRAWINGS

FIG. 1 is a diagram showing the commerce card merchant network system.

### DETAILED DESCRIPTION OF THE INVENTION

The present invention relates to a commerce card 10 and system 12 for conducting commerce. The commerce card 10 may be a physical card with a magnetic strip, card number, security code, bar code, QR code, RF ID chip, and/or any other indicia that uniquely identifies the commerce card. The commerce card may also be electronic in the form of a number, password, image, or any other indicia suitable for electronic transmission that uniquely identifies the commerce card. As used herein, commerce cards are used to fund the transaction (i.e. post transaction billing or concurrent account deduction, pre-paid balance deducted at or after transaction, etc.). Commerce cards are distinguishable from coupons or coupon cards, which can be used to reduce the price of goods/services for any given transaction but cannot be used to fund the transaction, and therefore are not commerce cards.

The commerce card features below may be configured by an originator, such as an individual, a group of individuals, a company, or any other entity. The commerce card may be provided, given or sold to a user or users, another person individually or members/employees of a group such as a family, sports club, company or government agency. The commerce card features may be available to any user or users, or only available to pre-identified or authorized users, or only available to users who are matching a criterion or a combination of criteria at the time of use of the commerce card.

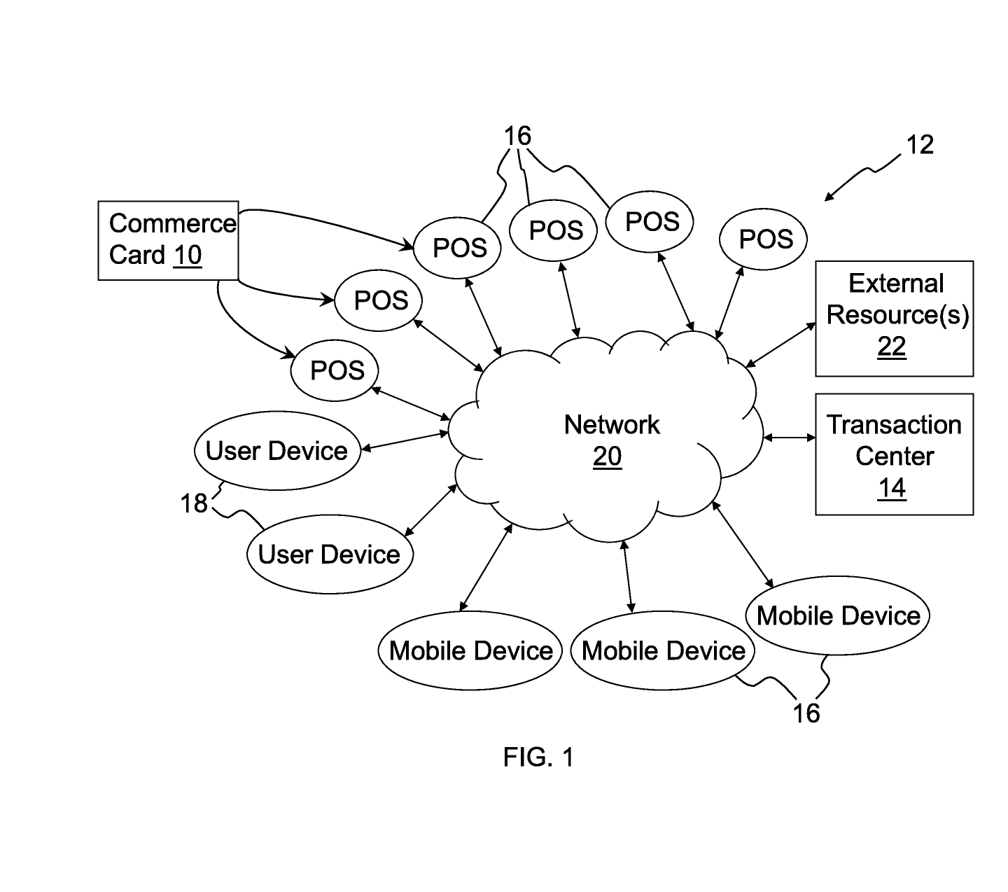

FIG. 1 illustrates the merchant network system 12 for processing commerce card transactions. The system 12 includes a transaction center 14 which can be one or more computing devices that set up and process commerce card accounts, and process merchant transactions involving the commerce cards. POS represents the Point of sale transaction devices (POS) 16 are devices used by merchants to complete a sales transaction using the commerce card. POS devices 16 can include store registers, card readers, input computer or device for commerce card numbers, etc. Information relating to the transaction (e.g. price, item description, item number, merchant ID number, etc.) and the commerce card (e.g. card number) can be entered into the transaction device 16 by keypad keystrokes, optical scanner, bar code reader, magnetic strip reader, RFID, etc. or any combination thereof. Mobile devices 16 can be any mobile device such as smart phones, tablets, etc. that the card user possesses during the transaction and that may be associated with or registered to the commerce card. User devices 18 can be any device such as computers, laptops, tablets, smart phones, etc. for which gifters and/or commerce card users can communicate with the transaction center 14 to set up, alter and/or monitor the settings or status for any given commerce card.

Network 20 can be one or more separate or inter-connected networks for communications between the transaction center 14, mobile devices 16, user devices 18 and POS devices 16. For example, network 14 could be a single network such as the Internet or a cell phone service provider network. Alternately, network 20 can include a merchant network for communications between the transaction center 14 and the POS devices 16, cellular or WiFi networks for communicating between the transaction center 14 and the mobile devices 16, and/or the Internet alone or in conjunction with WiFi networks or one or more other networks for communicating between the transaction center 14 and the user devices 18, mobile devices 16 and/or POS devices 16. External resource(s) 22 includes external sources of information, such as for example external data bases or resources (e.g. social media sites such as Yelp™ and Facebook™, other third party data bases or processing servers such as merchant servers, etc.) that can provide information used to process and/or authorize a commerce card transaction. Therefore, commerce transactions can be processed by the transaction center 14 alone (i.e. the transaction center 14 acts as the transaction processing device) or together with external resource(s) 22 (i.e. the transaction center 14 and external resource(s) 22 together act as the transaction processing device). Once the transaction is authorized (i.e. the decision is made to proceed with the transaction given the information provided), information is sent back to the POS 16 giving the merchant notice that the transaction is authorized and will be processed.

The commerce card 10 may be used at retail merchant stores (brick and mortar, or website) for purchasing goods and services and/or obtaining rewards, points or any other non-monetary value. The commerce card could act as a credit card (payment after use to purchase goods/services), a debit card, or a stored value card (payment before purchase of goods/services) to effectuate a payment. The commerce card could also act as a loyalty, rewards or points card, where rewards or points usable for rewards or purchase credits/discounts are awarded based on purchases. The commerce card could be a one-time value card or a reloadable value card. Unlike conventional credit, debit, stored value cards, reward cards or loyalty cards, the commerce card would have one or more of the features discussed below.

### Location/Time Access Limits

Use of the commerce card could be limited based upon location and/or time. The use of the commerce card could also be limited based on location and/or time, in combination with other criteria. The limitations could be inclusive or exclusive or a combination of both. Examples include but are not limited to:
Use of the commerce card is limited to all merchants within a single location such as a mall or shopping center, a city or a state, or several such locations. Alternately, use of the commerce card is limited to all merchants not within a single location such as a mall or shopping center, or a city or a state, or several such locations. This is referred to as allowed geographical area(s).
Use of the commerce card is limited to one or more, but not all, of the merchants within a single location such as a mall or shopping center, or a city or a state, or several such locations. This is referred to as allowed merchant(s) within allowed geographical area(s).
Use of the commerce card is limited to all merchants within a certain type of location, such as all mall type shopping areas, or all cities with a population of more than 1 million, or several such location types. Alternately, use of the commerce card is limited to all merchants not within a certain type of location, such as mall type shopping areas, or cities with a population of more than 1 million, or several such location types. This is referred to as allowed geographical area type(s).
Use of the commerce card is limited to one or more, but not all, merchants within a certain type(s) of location, such as all mall type shopping areas, or all US cities with a population of more than 1 million, or a combination of both criteria. This is referred to as allowed merchant(s) within allowed geographical area type(s).
Use of the commerce card is limited to one or more, but not all, of the stores within a single brand chain, based upon location. For example, the commerce card would work with a particular brand name restaurant within mall type shopping areas but not any stand-alone versions of such restaurant chain, or only with that brand chain's restaurants in cities below a certain population, or a combination of both criteria. This is referred to as allowed merchant store(s) within allowed geographical area(s).
Use of the commerce card is limited to one or more, but not all, stores within a single brand chain, based upon location and whether the business operation is a franchise or not. This is referred to as allowed merchant store type(s) within allowed geographical area(s).
Use of the commerce card is limited to certain white listed merchants at certain locations, such as favorite restaurant establishments chosen by the gifter of the card to an individual, or chosen based on corporate policies for an employee card, or chosen based on the opinions or behavior of other people (e.g., only merchants that more than 5 Facebook™ friends have “liked”). This is referred to as allowed merchant(s) within allowed geographical area(s).
Use of the commerce card is limited to certain white listed merchants at certain times, such as consumer electronics stores before 6 pm chosen by the parent (gifter of the card) to their teenage child, or based on ratings from an external guide such as Yelp™. This is referred to as allowed merchant(s) within allowed time period(s).
Use of the commerce card is limited to certain products or services sold at all merchants or just specific merchants. This is referred to as allowed product(s) or service(s), or allowed product(s) or service(s) with allowed merchant(s).
Use of the commerce card is limited by merchant type (e.g., only works with non-chain type merchants—i.e. mom and pop stores). This is referred to as allowed merchant type(s).
Use of the commerce card is limited to exclude certain black listed merchants such as bars, and/or certain black listed products such as alcohol. This is referred to as allowed merchant(s) and/or allowed product(s) or service(s). Additionally, time limitations could be included as part of this exclusion. This is referred to as allowed merchant(s) and/or allowed product(s) or service(s), and within allowed time period(s).
Use of the commerce card is limited to certain time limitations such as date, year, day of week, or hour of the day, such as only on and/or after the birthday of the user of the card, or on and/or after Valentine's day. This is referred to as within allowed time period(s).
Use of the commerce card is limited by certain time limitations in combination with location or merchant (e.g., favorite list of restaurants only on weekends). This is referred to as allowed merchant(s) or allowed geographical area(s) within allowed time period(s).
Use of the commerce card is limited based upon certain criteria such as types or brands of goods/services (e.g., limited to sports equipment, or limited to hair styling services, etc.). This is referred to as allowed type(s) or brand(s) of good(s) or service(s).
Use of the commerce card is limited based upon any combination of two or more of the limitations described above.

Any inclusive and/or exclusive limitations on merchants, goods/services, location, time etc. described above can be configured when the commerce card is originally issued, and/or over the life of the commerce card, by the issuer of the commerce card and/or a gifter of the commerce card. Any inclusive and/or exclusive limitations on merchants, goods/services, location, time etc. can be configured once, or can be modified in ad hoc fashion or based on preset rules such as the age of the user, the number of times the card has been used, the number of locations the card has been used at, or any other measurable or quantifiable element related to the user of the card, the originator of the card and/or the use of the card.

The processing of commercial transactions using the commerce card can be implemented by transaction center 14, which will preferably accept or deny transactions based upon any of the criteria described herein. Alternately, merchants can connect via network 20 or any other network to transaction center 14 to process commerce card transactions (i.e. one or more additional servers for processing the commerce card transactions work in conjunction with transaction center 14, working together as the transaction processing device). Preferably, the authentication and approval of the card transactions, including the verification that the purchase meets all the criteria limitations associated with the commerce card, happens in real-time or near real-time. Placing one or more of the listed limitations on the use of the commerce card gives the gifter or issuer control on how the commerce card is used, and/or drives business to or away from selected merchant(s) and/or products/services.

### User/External Criteria Access Limits

Use of the commerce card could be limited based upon criteria associated with the user or the user's behavior at the time the card is issued, at the time of the transaction, and/or in conjunction with external information. Examples include but are not limited to:
Use of the commerce card is limited based upon past user transaction conduct (i.e. disallowed user conduct). For example, the user cannot purchase alcohol in a bar (transaction declined) if they have already purchased $30 of drinks that day or over some other time period.
Use of the commerce card is limited based upon past user transaction conduct in combination with time and location limitations and/or any other criteria (i.e. disallowed user conduct outside of allowed geographical area and/or time constraints). For example, the user cannot purchase alcohol in a bar (transaction declined) if they have already purchased $30 of drinks in this bar or other bars within 5 miles in the last 5 hours (here past transactions combined with time and location).
Use of the commerce card is limited based on conduct or input from third parties or external resources (e.g. social media). For example, the commerce card can only be used in a given store if 5 people in the user's Facebook™ friends list have “liked” the store. Conversely, the commerce card cannot be used at a given store that does not have at least 3 stars on Yelp™ or a certain rating with the Better Business Bureau. These examples involve accessing and using external resources 22 that are used to qualify the transaction at a given time (or within a certain time period).

### Fraud Protection Limitations

The commerce card can be associated with the user's mobile device (e.g. cell phone, tablet, portable computer, etc.) whereby transactions would require additional user verification utilizing the user's mobile device. For example, the user's mobile device can be used to verify the location of the user (e.g. GPS or cellular network or WiFi confirmation of location), such that the transaction is approved only if the location of the point of sale (POS) matches the detected location of user's mobile device. Other uses of the user's mobile device to authenticate the user include but are not limited to:
The transaction is approved only if the user successfully enters a pin number or password on an application running on the user's mobile device (which is separately sent to the server or transaction center 14 processing the transaction), or the user sends an email or text message having required content to the server or the transaction center 14 processing the transaction, where the pin number or password is associated either with the commerce card or the particular transaction (e.g. sales clerk provides the pin number/password and the transaction is approved only if that pin/password is received from a mobile device associated with the commerce card).
The transaction is approved only if the user takes a picture of a code or an image at POS, and sends to a server or the transaction center 14.
The transaction is approved only if the POS records or scans a picture or code stored or delivered to the user's mobile device, and the code or image is sent to a server or the transaction center 14.
The transaction is denied if the location or time of the transaction is outside a typical pattern of detected locations and times of the user (as detected using the mobile device).
The transaction is approved only if the level of risk is below a certain threshold. For example, a risk level can be created for the transaction based upon the card's use, location of the user's mobile device, method of authentication using the mobile device, etc., whereby the risk level is provided to the merchant in real-time. The merchant then decide to proceed with the transaction if the risk level is sufficiently low enough.

In the above examples, the user's mobile device is registered with the merchant's server and/or the transaction center 14, and linked to the user's commerce card. This authentication is especially desirable because it works in conjunction with the user's mobile device (i.e. both the user's commerce card and mobile device are required to complete the transaction). Authentication using the user's mobile device can be active which requires the user to take a particular action with their mobile device as described above as part of the transaction, and which could include the additional step of unlocking their device using a code or password thus adding an additional layer of security to the transaction. Alternately, authentication using the user's mobile device can be passive so long as the mobile device is simply turned on and connected to the WiFi or cellular network (where the user's mobile device is used automatically in the background to authenticate the transaction).

### Card Originator Feedback and Control

The card originator can receive feedback about the usage of the commerce card, and/or control of the card's use even after the card's origination. Examples include but are not limited to:
System 12 sends a message to the card originator each time the commerce card is used, with details of the transaction. The messaging could be selectively filtered, so that use messages are sent only under certain circumstances. For example, use messages are sent only if the commerce card is used within or without certain time periods, and/or if the commerce card is used within or without certain geographic boundaries.
System 12 could use the messaging feature as part of the transaction approval process, whereby the transaction is completed only if the originator responds to the message with approval, thus providing the originator with real-time approval power over transaction (e.g. parental control).
Corporations or other business entities can monitor transactions involving commerce cards provided to its employees or members. For example, employee/member use of the commerce card can be monitored, including location verification using the user's mobile device location compared to location of card use, to ensure proper use of the commerce card. Employee/member use of the commerce card can be configured to pre-authorize expected classes of use depending upon employee's expected travel and use schedule. This preauthorization can involve manual confirmation (i.e. messaging) or automated confirmation (i.e. a company/entity server is checked as part of the transaction authorization process to confirm that the card is authorized for that transaction (i.e. location, time/date, types of goods/services, etc. based on the employee/member expected travel/activities).

### 5. Entertainment

The originator of the commerce card can set up its use parameters for the goal of entertainment. For example, the commerce card can be configured and used in a manner that resembles a treasure hunt, where the user must figure out where and/or when the card transactions are authorized. The commerce card can be configured to include “surprise” or bonus value or discounts upon use, based on the card's use. The commerce card can be configured so that it can only be used within the time period or geographic boundary of the use of another one or several commerce cards.

It is to be understood that the present invention is not limited to the embodiment(s) described above and illustrated herein, but encompasses any and all variations falling within the scope of the appended claims. For example, references to the present invention herein are not intended to limit the scope of any claim or claim term, but instead merely make reference to one or more features that may be covered by one or more of the claims. The various card features and use limitations described above can be implemented separately or combined together partially or completely. Network 20 collectively refers to all separate and/or connected networks, so any given communication can use the same or different network(s) as any other communication.

Hardware, software and/or firmware can be used to implement the logic steps, features and/or processes of the invention. It should further be appreciated that such logic steps, features or processes can be implemented as computer-executable instructions stored on a non-transitory computer readable medium, such a CD or DVD (including re-writable CDs and DVDs), flash or other non-volatile memory, ROM, EEPROM, disc drive, solid state drive, etc. Specifically, the present invention can be embodied in the form of methods and apparatus for practicing those methods. The present invention can also be embodied in the form of program code embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

The software is stored in a machine readable medium that may take many forms, including but not limited to, a tangible storage medium, a carrier wave medium or physical transmission medium. Non-volatile storage media include, for example, optical or magnetic disks, such as any of the storage devices in any computer(s) or the like. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: disks (e.g., hard, floppy, flexible) or any other magnetic medium, a CD-ROM, DVD or DVD-ROM, any other optical medium, any other physical storage medium, a RAM, a PROM and EPROM, a FLASH-EPROM, any other memory chip, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

What is claimed is:

1. A method of authorizing a transaction, comprising:
receiving, by a transaction processing device over a network, information relating to a transaction and a commerce card sent by a transaction device;
receiving, by the transaction processing device over a network, information sent from a mobile device associated with the commerce card; and
authorizing, by the transaction processing device, the transaction based on the information received from the transaction device and the information received from the mobile device.

2. The method of claim 1, further comprising:
sending, by the transaction processing device, information relating to the authorizing of the transaction to the transaction device.

3. The method of claim 1, wherein:
the information received from the mobile device includes location information of the mobile device; and
the authorizing includes comparing a location of the transaction device with the location information sent from the mobile device.

4. The method of claim 1, further comprising:
determining, by the transaction processing device, a location of the transaction device;
wherein:
the information received from the mobile device includes location information of the mobile device; and
the authorizing includes comparing the determined location of the transaction device with the location information sent from the mobile device.

5. The method of claim 1, wherein:
the information received from the mobile device includes a pin number or password; and
the authorizing includes comparing the pin number or password received from the mobile device with a pin number or password associated with the commerce card or the transaction.

6. The method of claim 1, wherein:
the information received from the mobile device includes an image; and
the authorizing includes comparing the image received from the mobile device with an image associated with the commerce card or the transaction.

7. The method of claim 1, wherein the authorizing includes generating a risk level based on the information received from the transaction device and the information received from the mobile device, and wherein the method further comprises:
sending, by the transaction processing device, the risk level to the transaction device.

8. A system for authorizing a transaction, comprising:
a transaction device configured to send over a network information relating to a transaction and a commerce card;
a transaction processing device configured to receive over the network the information sent by the transaction device and information sent from a mobile device associated with the commerce card, wherein the transaction processing device is configured to authorize the transaction based on the information received from the transaction device and the information received from the mobile device.

9. The system of claim 8, wherein the transaction processing device is further configured to send information relating to the authorizing of the transaction to the transaction device.

10. The system of claim 8, wherein:
the information received from the mobile device includes location information of the mobile device; and
the transaction processing device is configured to authorize the transaction by comparing a location of the transaction device with the location information sent from the mobile device.

11. The system of claim 8, wherein the transaction processing device is further configured to determine a location of the transaction processing device; and
wherein:
the information received from the mobile device includes location information of the mobile device; and
the transaction processing device is further configured to authorize the transaction by comparing the determined location of the transaction device with the location information sent from the mobile device.

12. The system of claim 8, wherein:
the information received from the mobile device includes a pin number or password; and
the transaction processing device is configured to authorize the transaction by comparing the pin number or password received from the mobile device with a pin number or password associated with the commerce card or the transaction.

13. The system of claim 8, wherein:
the information received from the mobile device includes an image; and
the transaction processing device is configured to authorize the transaction by comparing the image received from the mobile device with an image associated with the commerce card or the transaction.

14. The system of claim 8, wherein the transaction processing device is configured to generate a risk level based on the information received from the transaction device and the information received from the mobile device, and to send the risk level to the transaction device.
